(19) United States
(12) Patent Application Publication
(10) Pub. No.: US 2017/0064714 A1
(43) Pub. Date: Mar. 2, 2017

(54) Data Transmission Method and Apparatus and Switch

(71) Applicant: Huawei Technologies Co., Ltd., Shenzhen (CN)

(72) Inventors: Gang Huang, Shanghai (CN); Wenliang Liang, Shanghai (CN); Haihua Shen, Shanghai (CN)

(21) Appl. No.: 15/349,476

(22) Filed: Nov. 11, 2016

Related U.S. Application Data
(63) Continuation of application No. PCT/CN2014/077278, filed on May 12, 2014.

(51) Int. Cl. H04W 72/04; H04W 72/10

(52) U.S. Cl. CPC H04W 72/0453; H04W 72/10

(57) ABSTRACT

A data transmission method includes dividing a channel into two sub-channels at a node, where the node is a point at which the channel and a backplane intersect; and performing data transmission with at least one server using the sub-channels. In this process, each sub-channel obtained by means of division can exclusively use all bandwidth of an original channel, so that a server can be connected to a switch using a plurality of sub-channels and occupy bandwidth of a plurality of channels. Therefore, in the embodiments of the present disclosure, a low-bandwidth switch can be used to implement large-scale real-time data exchange in a centralized data processing process, thereby reducing costs of the switch to some extent.

### CROSS-REFERENCE TO RELATED APPLICATION

This application is a continuation of International Application No. PCT/CN2014/077278, filed on May 12, 2014, the disclosure of which is hereby incorporated by reference in its entirety.

### TECHNICAL FIELD

The present disclosure relates to the field of wireless communications technologies, and in particular, to a data transmission method and apparatus and a switch.

### BACKGROUND

With rapid development of mobile communications technologies, wireless communications systems are developing towards mobile, broadband, and Internet Protocol (IP)-based systems, competitions in the mobile communications market are becoming more intense, and technical updates are becoming more frequent. To reduce costs, future base stations will mostly use a form of a centralized data center, and large-scale real-time data processing is performed by a plurality of servers in the centralized data center. In this data processing manner, servers in the centralized data center will face great data exchange pressures.

In the prior art, high-bandwidth low-delay switches are configured according to peak requirements needed by uplink and downlink of servers, and high-performance switches are used to implement mesh interconnection of the servers in the centralized data center, so as to ensure that bandwidth and access delay between the servers can satisfy large-scale real-time data processing.

Although the high-performance switches can meet data communication requirements between the servers, the high-performance switches have relatively high costs. In addition, prices of switches with the same performance may reduce gradually in future developments. However, because of continuous developments of communications technologies, there will be an increasing quantity of servers in a centralized data center, and requirements for the scale and real-time quality of data processing become higher. Consequently, costs of switches in the entire system cannot be reduced easily.

### SUMMARY

Embodiments of the present disclosure provide a data transmission method and apparatus and a switch, so that a low-bandwidth switch is used to implement large-scale real-time data exchange in a centralized data processing process, thereby achieving an objective of reducing system costs.

According to a first aspect, an embodiment of the present disclosure provides a data transmission method, including dividing a channel into at least two sub-channels at a node, where the node is a point at which the channel and a backplane intersect; and performing data transmission with at least one server using the sub-channels.

In a first possible implementation manner of the first aspect, when the channel is a downlink channel, the dividing a channel into at least two sub-channels at a node includes dividing the downlink channel into at least two downlink sub-channels at the node; before performing data transmission with at least one server using the sub-channels, the method includes replicating a downlink data packet, where a quantity of replicates is the same as a quantity of the downlink sub-channels; and performing data transmission with at least one server using the sub-channels includes sending the downlink data packets to the at least one server using the downlink sub-channels.

In a second possible implementation manner of the first aspect, when the channel is an uplink channel, dividing a channel into at least two sub-channels at a node includes dividing the uplink channel into at least two uplink sub-channels at the node; and performing data transmission with at least one server using the sub-channels includes receiving uplink data packets that are sent by the at least one server using the uplink sub-channels.

With reference to the second possible implementation manner of the first aspect, in a third possible implementation manner of the first aspect, before receiving uplink data packets that are sent by the at least one server using the uplink sub-channels, the method further includes, if a conflict exists when the at least one server sends the uplink data packets using the uplink sub-channels, making arbitration on the at least one server to obtain an arbitration result; and receiving uplink data packets that are sent by the at least one server using the uplink sub-channels includes receiving, according to the arbitration result, an uplink data packet that is sent by a selected server using an uplink sub-channel connected to the selected server.

With reference to the third possible implementation manner of the first aspect, in a fourth possible implementation manner of the first aspect, making arbitration on the at least one server to obtain an arbitration result includes making the arbitration on the at least one server according to at least one of a priority of the at least one server, or a priority of a data packet sent by the at least one server.

With reference to any one of the first aspect, or the first to the fourth implementation manners of the first aspect, in a fifth possible implementation manner of the first aspect, after dividing a channel into at least two sub-channels at a node, the method further includes allocating bandwidth to the at least one server according to a bandwidth requirement of the at least one server connected to the sub-channels.

According to a second aspect, an embodiment of the present disclosure provides a data transmission apparatus, including a division module configured to divide a channel into at least two sub-channels at a node, where the node is a point at which the channel and a backplane intersect; and a transmission module configured to perform data transmission with at least one server using the sub-channels obtained by means of division by the division module.

In a first possible implementation manner of the second aspect, the apparatus further includes a replication module; the division module is configured to, when the channel is a downlink channel, divide the downlink channel into at least two downlink sub-channels at the node; the replication module is configured to replicate a downlink data packet, where a quantity of replicates is the same as a quantity of the downlink sub-channels obtained by means of division by the division module; and the transmission module is configured to send the downlink data packets replicated by the replication module to the at least one server using the downlink sub-channels.

In a second possible implementation manner of the second aspect, the division module is configured to, when the channel is an uplink channel, divide the uplink channel into at least two uplink sub-channels at the node; and the transmission module is configured to receive uplink data packets that are sent by the at least one server using the uplink sub-channels.

With reference to the second possible implementation manner of the second aspect, in a third possible implementation manner of the second aspect, the apparatus further includes an arbitration module configured to, if a conflict exists when the at least one server sends the uplink data packets using the uplink sub-channels, make arbitration on the at least one server to obtain an arbitration result; where the transmission module is configured to receive, according to the arbitration result of the arbitration module, an uplink data packet that is sent by a selected server using an uplink sub-channel connected to the selected server.

With reference to the third possible implementation manner of the second aspect, in a fourth possible implementation manner of the second aspect, the arbitration module is configured to make the arbitration on the at least one server according to at least one of the following: a priority of the at least one server; or a priority of a data packet sent by the at least one server.

With reference to any one of the second aspect, or the first to the fourth implementation manners of the second aspect, in a fifth possible implementation manner of the second aspect, the apparatus further includes an allocation module configured to, after the division module divides the channel into the at least two sub-channels at the node, allocate bandwidth to the at least one server according to a bandwidth requirement of the at least one server connected to the sub-channels.

According to a third aspect, an embodiment of the present disclosure provides a switch, including a processor and a memory, where the memory stores an execution instruction, and when the switch operates, the processor communicates with the memory, and the processor executes the execution instruction to cause the switch to execute any one of the foregoing first aspect, or the first to the fifth possible implementation manners of the first aspect.

The data transmission method and apparatus and the switch provided in the embodiments of the present disclosure can be applied to a channel that is connected to a backplane, where the channel is divided into a plurality of sub-channels at a node, that is, at a point at which the channel and the backplane intersect, and the sub-channels are connected to different servers. In this process, each of the sub-channels obtained by means of division can exclusively use all bandwidth of the original channel, so that a server can be connected to a switch using a plurality of sub-channels and occupy bandwidth of a plurality of channels. Therefore, in the embodiments of the present disclosure, a low-bandwidth switch can be used to implement large-scale real-time data exchange in a centralized data processing process, thereby reducing costs of the switch to some extent.

### BRIEF DESCRIPTION OF THE DRAWINGS

FIG. 1 is a flowchart of Embodiment 1 of a data transmission method according to the present disclosure;

FIG. 2 is a schematic diagram of a system architecture to which a data transmission method according to the present disclosure is applicable;

FIG. 3 is a schematic process diagram of Embodiment 2 of a data transmission method according to the present disclosure;

FIG. 4 is a schematic process diagram of Embodiment 3 of a data transmission method according to the present disclosure;

FIG. 5 is a schematic structural diagram of Embodiment 1 of a data transmission apparatus according to the present disclosure;

FIG. 6 is a schematic structural diagram of Embodiment 2 of a data transmission apparatus according to the present disclosure; and

FIG. 7 is a schematic structural diagram of a switch according to the present disclosure.

### DETAILED DESCRIPTION

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

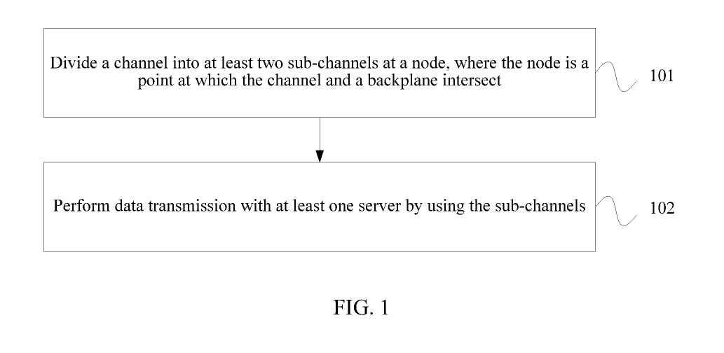

FIG. 1 is a flowchart of Embodiment 1 of a data transmission method according to the present disclosure. This embodiment is executed by a switch, and is applicable in a scenario in which all servers perform large-scale real-time data exchange when the servers are interconnected using the switch in a centralized data processing process. This embodiment includes the following steps.

101: Divide a channel into at least two sub-channels at a node, where the node is a point at which the channel and a backplane intersect.

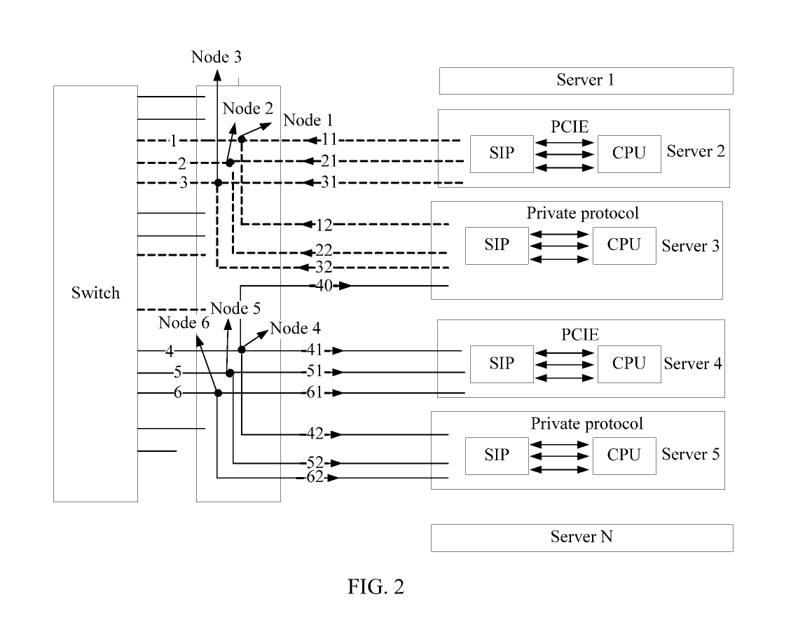

Generally, a switch may include several channels which are also referred to as ports, the switch has a physical connection with a server using these channels, and these channels are, for example, uplink channels or downlink channels. In this step, all channels of the switch or some of the channels that are independent are connected to the backplane in advance, and the backplane may be a backplane that is disposed on the switch and has a connection function on a manager, a line card or the like of the switch, or a backplane that is newly disposed and independent of the switch. For a channel that is connected to the backplane, the channel is divided into at least two sub-channels at a node, and each of the sub-channels can exclusively use all bandwidth of the original channel. Then, the sub-channels are connected to different servers or a same server. The node is a point at which the channel and the backplane intersect. For details, refer to FIG. 2.

FIG. 2 is a schematic diagram of a system architecture to which a data transmission method according to the present disclosure is applicable. As shown in FIG. 2, in the system architecture, the switch is, for example, a switch based on a crossbar structure, and the backplane is, for example, a backplane that is independent of the switch. The switch has a plurality of channels, and in the figure, solid lines are downlink channels, and dashed lines are uplink channels. The server includes, for example, a central processing unit (CPU), a Session Initiation Protocol (SIP) unit, and the like. Peripheral Component Interconnect Express (PCIE) may be used to perform communication between the SIP unit and the CPU. Alternatively, a private protocol may be used to perform communication, which is not limited in the present disclosure.

With reference to FIG. 2, using an uplink channel 1 as an example, the uplink channel 1 and the backplane intersect at a node 1, and the uplink channel 1 is divided into an uplink sub-channel 11 and an uplink sub-channel 12 at the node 1, where the uplink sub-channel 11 is connected to a server 2, and the uplink sub-channel 12 is connected to a server 3. Similarly, an uplink channel 2 is divided into an uplink sub-channel 21 and an uplink sub-channel 22 at a node 2, where the uplink sub-channel 21 is connected to the server 2, and the uplink sub-channel 22 is connected to the server 3; an uplink channel 3 is divided into an uplink sub-channel 31 and an uplink sub-channel 32 at a node 3, where the uplink sub-channel 31 is connected to the server 2, and the uplink sub-channel 32 is connected to the server 3. However, for a downlink channel, using a downlink channel 4 as an example, the downlink channel 4 and the backplane intersect at a node 4, and the downlink channel 4 is divided into a downlink sub-channel 40, a downlink sub-channel 41, and a downlink sub-channel 42 at the node 4, where the downlink sub-channel 40 is connected to the server 3, the downlink sub-channel 41 is connected to a server 4, and the downlink sub-channel 42 is connected to a server 5; similarly, a downlink channel 5 is divided into a downlink sub-channel 51 and a downlink sub-channel 52 at a node 5, where the downlink sub-channel 51 is connected to the server 4, and the downlink sub-channel 52 is connected to the server 5; and a downlink channel 6 is divided into a downlink sub-channel 61 and a downlink sub-channel 62 at a node 6, where the downlink sub-channel 61 is connected to the server 4, and the downlink sub-channel 62 is connected to the server 5.

Optionally, after the channel is divided into at least two sub-channels at a node, the switch may further allocate bandwidth to at least one server according to a bandwidth requirement of a server connected to each sub-channel.

A quantity of channels of the switch is fixed. After connection relationships of sub-channels of each channel and a server are configured, bandwidth for the server to access the switch may be allocated to the server according to a requirement of the server. Referring to FIG. 2, the uplink channel 1 to the uplink channel 3 may be shared between the server 2 and the server 3. When receiving uplink data, the switch may evenly allocate the uplink channel 1 to the uplink channel 3 to the server 2 according to a priority of at least one server. For example, the uplink sub-channel 11, the uplink sub-channel 21, and the uplink sub-channel 31 are enabled, and the uplink sub-channel 12, the uplink sub-channel 22, and the uplink sub-channel 32 are disclosed, so that the server 2 exclusively uses the uplink channel 1 to the uplink channel 3. Alternatively, some of the uplink channels may be allocated to the server 2. For example, the uplink channel 1 and the uplink channel 3 are allocated to the server 2, and the uplink channel 2 is allocated to the server 3. In this process, for the server 2, the uplink sub-channel 11 and the uplink sub-channel 31 are enabled, and the uplink sub-channel 21 is disabled; and for the server 3, the uplink sub-channel 21 is enabled, and the uplink sub-channel 11 and the uplink sub-channel 31 are disabled.

Optionally, asymmetric uplink and downlink bandwidth is provided to each server, that is, uplink and downlink bandwidth provided to each server may be different. Referring to FIG. 2, downlink bandwidth that is allocated to the server 3 is bandwidth provided by the sub-channel 40 of the channel 4, and uplink bandwidth that is allocated to the server 3 is bandwidth provided by all or some of the uplink sub-channel 12, the uplink sub-channel 22, and the uplink sub-channel 32.

102: Perform data transmission with at least one server using the sub-channels.

For each server, the switch sends downlink data packet to the server using a downlink sub-channel between the switch and the server. Alternatively, the switch receives an uplink data packet that is sent by the server using an uplink sub-channel between the switch and the server.

Optionally, the switch may maintain a mapping table of mapping information between servers and channels. For example, a functional entity may be added to maintain the corresponding information table. In this way, after receiving a data packet, the switch finds a corresponding channel in the mapping table according to a server identifier carried by the data packet, and sends the data packet using the found channel.

The data transmission method provided in this embodiment of the present disclosure can be applied to a channel that is connected to a backplane, where the channel is divided into a plurality of sub-channels at a node, that is, at a point at which the channel and the backplane intersect, and the sub-channels are connected to different servers. In this process, each of the sub-channels obtained by means of division can exclusively use all bandwidth of the original channel, so that a server can be connected to a switch using a plurality of sub-channels and occupy bandwidth of a plurality of channels. Therefore, in the embodiments of the present disclosure, a low-bandwidth switch can be used to implement large-scale real-time data exchange in a centralized data processing process, thereby reducing costs of the switch to some extent.

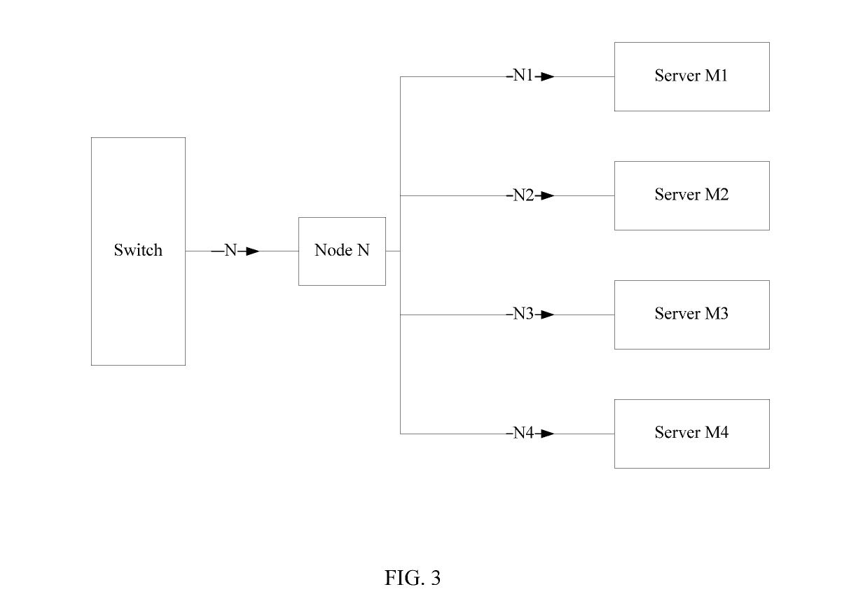

Optionally, in the foregoing Embodiment 1, when the channel is a downlink channel, the switch divides the downlink channel into at least two downlink sub-channels at the node. In this case, in a process of sending a downlink data packet, the downlink data packet is first replicated, and a quantity of replicates is the same as a quantity of the downlink sub-channels. Then, the downlink data packets are sent to at least one server using the downlink sub-channels, and each server selects to receive a data packet that is needed according to a requirement of the server itself and drops a useless data packet. For details, refer to FIG. 3.

FIG. 3 is a schematic process diagram of Embodiment 2 of a data transmission method according to the present disclosure. In this embodiment, it is assumed that the switch sends a downlink data packet to servers, and a downlink channel N is divided into 4 downlink sub-channels at a node N, where the 4 downlink sub-channels respectively are a downlink sub-channel N1, a downlink sub-channel N2, a downlink sub-channel N3, and a downlink sub-channel N4. The downlink sub-channel N1 is connected to a server M1, the downlink sub-channel N2 is connected to a server M2, the downlink sub-channel N3 is connected to a server M3, and the downlink sub-channel N4 is connected to a server M4.

With reference to FIG. 3, in the process of sending a downlink data packet, the switch first receives the downlink data packet using the downlink channel N and replicates the downlink data packet at the node N, where a quantity of replicates is 4; then, the switch sends the downlink data packets to servers connected to the downlink sub-channels using the downlink sub-channels, and the servers select to receive a data packet that is needed according to requirements of the servers, and drops a useless data packet.

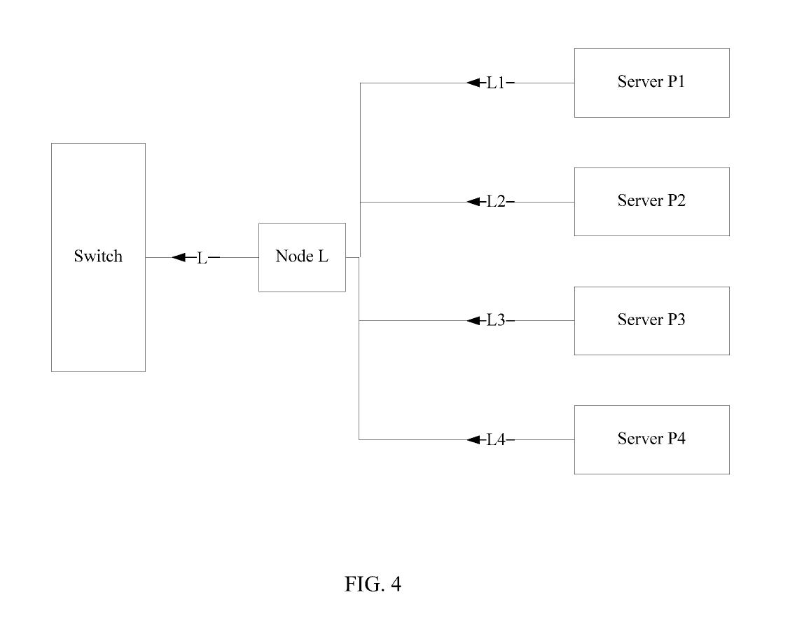

Optionally, in the foregoing Embodiment 1, when the channel is an uplink channel, the switch divides the uplink channel into at least two uplink sub-channels at the node. In this case, the switch receives an uplink data packet that is sent by at least one server using an uplink sub-channel connected to the server. In a process of receiving the uplink data packet, for a plurality of uplink sub-channels that is divided from an uplink channel, the uplink sub-channels are connected to different servers. Therefore, the switch may select to connect to only one of the uplink sub-channels. In this case, the switch only receives an uplink data packet that is sent by a server connected to the uplink sub-channel. Alternatively, a module with functions of sending uplink data and arbitrating may be arranged. For example, the arbitration module may be disposed on a node or disposed independently. If the node determines that a conflict exists when the at least one server sends an uplink data packet using the uplink sub-channels connected to the server, the arbitration module makes arbitration on the at least one server to obtain an arbitration result, and selects a server according to the arbitration result, so that the switch only receives an uplink data packet that is sent by the selected server using an uplink sub-channel connected to the server. Alternatively, the switch receives uplink data packets that are sent by the servers successively according to the arbitration result. For details, refer to FIG. 4.

FIG. 4 is a schematic process diagram of Embodiment 3 of a data transmission method according to the present disclosure. In this embodiment, it is assumed that servers send uplink data packets to the switch, and an uplink channel L is divided into 4 uplink sub-channels at a node L, where the 4 uplink sub-channels respectively are an uplink sub-channel L1, an uplink sub-channel L2, an uplink sub-channel L3, and an uplink sub-channel L4. The uplink sub-channel L1 is connected to a server P1, the uplink sub-channel L2 is connected to a server P2, the uplink sub-channel L3 is connected to a server P3, and the uplink sub-channel L4 is connected to a server P4.

With reference to FIG. 4, in a process of receiving the uplink data packets, if there is only one server sending an uplink data packet to the switch, a data packet conflict does not exist, and the uplink data packet is directly sent. When a plurality of servers sends uplink data packets to the switch at the same time, for example, assuming that the server P1, the server P2, and the server P4 all have demands for sending uplink data to the switch, at least one server sends an uplink data request to the node L. The node L determines, according to the received requests, that a conflict exists when the at least one server sends uplink data. In this case, an arbitration module makes arbitration on the at least one server, and selects one server, for example, the server P4 according to an arbitration result; an uplink sub-channel corresponding to the server P4 is connected to the uplink channel L, and the uplink data packet is sent using the uplink sub-channel. In this process, the arbitration module may make arbitration according to at least one of the following: a priority of the at least one server, a priority of a data packet sent by the at least one server or the like, so as to obtain the arbitration result. For example, the arbitration module may store the priority of the at least one server in advance and sort the at least one server according to the priority. Alternatively, the arbitration module may select a server according to a type of the uplink data packet or the like.

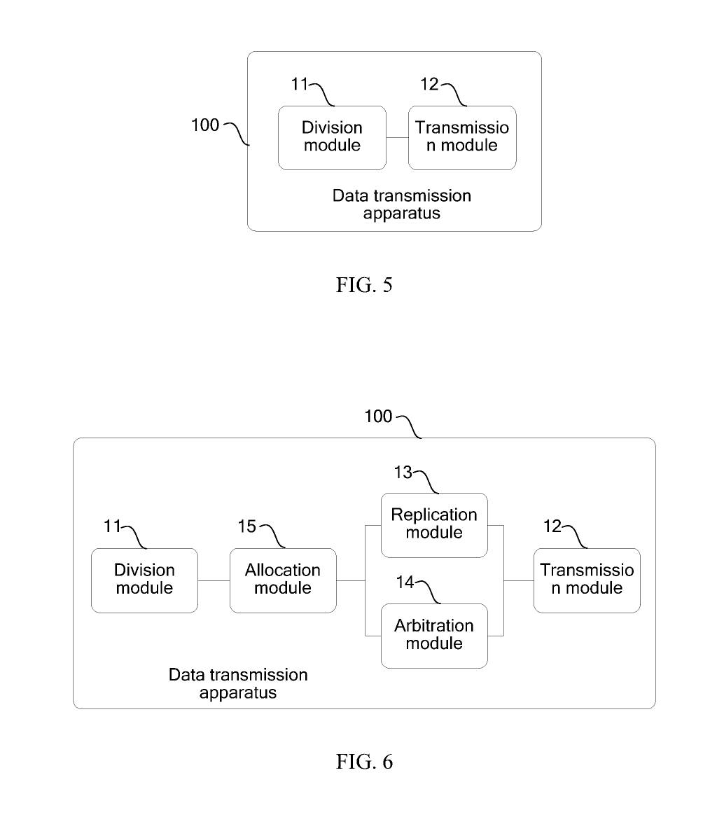

FIG. 5 is a schematic structural diagram of Embodiment 1 of a data transmission apparatus according to the present disclosure. The data transmission apparatus provided in this embodiment is an apparatus embodiment corresponding to the embodiment of the present disclosure in FIG. 1, and a specific implementation process is not described in detail herein. A data transmission apparatus 100 provided in this embodiment includes a division module 11 configured to divide a channel into at least two sub-channels at a node, where the node is a point at which the channel and a backplane intersect; and a transmission module 12 configured to perform data transmission with at least one server using the sub-channels obtained by means of division by the division module 11.

The data transmission apparatus provided in this embodiment of the present disclosure can be applied to a channel that is connected to a backplane, where the channel is divided into a plurality of sub-channels at a node, that is, at a point at which the channel and the backplane intersect, and the sub-channels are connected to different servers. In this process, each of the sub-channels obtained by means of division can exclusively use all bandwidth of the original channel, so that a server can be connected to a switch using a plurality of sub-channels and occupy bandwidth of a plurality of channels. Therefore, in the embodiments of the present disclosure, a low-bandwidth switch can be used to implement large-scale real-time data exchange in a centralized data processing process, thereby reducing costs of the switch to some extent.

FIG. 6 is a schematic structural diagram of Embodiment 2 of a data transmission apparatus according to the present disclosure. As shown in FIG. 6, on the basis of an apparatus structure in FIG. 5, the data transmission apparatus 100 according to this embodiment further includes a replication module 13; the division module 11 is configured to, when the channel is a downlink channel, divide the downlink channel into at least two downlink sub-channels at the node; the replication module 13 is configured to replicate a downlink data packet, where a quantity of replicates is the same as a quantity of the downlink sub-channels obtained by means of division by the division module 11; and the transmission module 12 is configured to send the downlink data packets replicated by the replication module 13 to at least one server using the downlink sub-channels.

Optionally, in an embodiment of the present disclosure, the division module 11 is configured to, when the channel is an uplink channel, divide the uplink channel into at least two uplink sub-channels at the node; and the transmission module 12 is configured to receive uplink data packets that are sent by at least one server using the uplink sub-channels.

Referring to FIG. 6 again, optionally, in an embodiment of the present disclosure, the apparatus further includes an arbitration module 14 configured to, if a conflict exists when at least one server sends the uplink data packets using the uplink sub-channels, make arbitration on the at least one server to obtain an arbitration result, where the transmission module 12 is configured to receive, according to the arbitration result of the arbitration module 14, an uplink data packet that is sent by a selected server using an uplink sub-channel connected to the selected server.

Further, optionally, in an embodiment of the present disclosure, the arbitration module 14 is configured to make arbitration on the at least one server according to at least one of the following: a priority of the at least one server; or a priority of a data packet sent by the at least one server.

Referring to FIG. 6 again, optionally, in an embodiment of the present disclosure, the apparatus further includes an allocation module 15 configured to, after the division module 11 divides the channel into at least two sub-channels at the node, allocate bandwidth to at least one server according to a bandwidth requirement of the at least one server connected to the sub-channels.

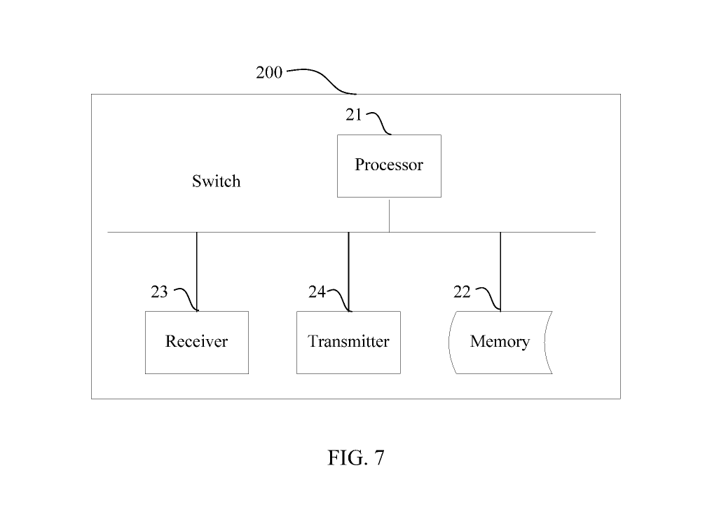

FIG. 7 is a schematic structural diagram of a switch according to the present disclosure. As shown in FIG. 7, a switch 200 provided in this embodiment includes a processor 21 and a memory 22. The switch 200 may further include a transmitter 24 and a receiver 23. The transmitter 24 and the receiver 23 may be connected to the processor 21. The transmitter 24 is configured to send data or information, the receiver 23 is configured to receive the data or the information, and the memory 22 stores an execution instruction. When the switch 200 operates, the processor 21 communicates with the memory 22, and the processor 21 calls the execution instruction in the memory 22 to execute the method embodiment shown in FIG. 1. Their implementation principles and technical effects are similar, and details are not described herein again.

Persons of ordinary skill in the art may understand that all or some of the steps of the method embodiments may be implemented by a program instructing relevant hardware. The program may be stored in a computer-readable memory medium. When the program runs, the steps of the method embodiments are performed. The foregoing memory medium includes any medium that can store program code, such as a read-only memory (ROM), a random-access memory (RAM), a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A data transmission method, comprising:
dividing a channel into at least two sub-channels at a node, wherein the node is a point at which the channel and a backplane intersect; and
performing data transmission with at least one server using the sub-channels.

2. The method according to claim 1, wherein when the channel is a downlink channel, dividing the channel into the at least two sub-channels at the node comprises dividing the downlink channel into at least two downlink sub-channels at the node, wherein before performing the data transmission with the at least one server using the sub-channels, the method comprises replicating a downlink data packet, wherein a quantity of replicates is the same as a quantity of the downlink sub-channels, and wherein performing the data transmission with the at least one server using the sub-channels comprises sending the downlink data packets to the at least one server using the downlink sub-channels.

3. The method according to claim 1, wherein when the channel is an uplink channel, dividing the channel into the at least two sub-channels at the node comprises dividing the uplink channel into at least two uplink sub-channels at the node, and wherein performing the data transmission with at least one server using the sub-channels comprises receiving uplink data packets that are sent by the at least one server using the uplink sub-channels.

4. The method according to claim 3, wherein before receiving the uplink data packets that are sent by the at least one server using the uplink sub-channels, the method further comprises making arbitration on the at least one server to obtain an arbitration result when the at least one server sends the uplink data packets using the uplink sub-channels and a conflict exists, and wherein receiving the uplink data packets that are sent by the at least one server using the uplink sub-channels comprises receiving, according to the arbitration result, an uplink data packet that is sent by a selected server using an uplink sub-channel connected to the selected server.

5. The method according to claim 4, wherein making the arbitration on the at least one server to obtain the arbitration result comprises making the arbitration on the at least one server according to at least one of the following: a priority of the at least one server; or a priority of a data packet sent by the at least one server.

6. The method according to claim 1, wherein after dividing the channel into the at least two sub-channels at a node, the method further comprises allocating bandwidth to the at least one server according to a bandwidth requirement of the at least one server connected to the sub-channels.

7. A data transmission apparatus, comprising:
a non-transitory computer readable medium having instructions stored thereon; and
a computer processor coupled to the non-transitory computer readable medium and configured to:
divide a channel into at least two sub-channels at a node, wherein the node is a point at which the channel and a backplane intersect; and
perform data transmission with at least one server using the sub-channels obtained by means of division.

8. The apparatus according to claim 7, wherein the computer processor is further configured to execute the instructions to:
divide a downlink channel into at least two downlink sub-channels at the node when the channel is the downlink channel;
replicate a downlink data packet, wherein a quantity of replicates is the same as a quantity of the downlink sub-channels obtained by means of division; and
send the downlink data packets that have been replicated to the at least one server using the downlink sub-channels.

9. The apparatus according to claim 7, wherein the computer processor is further configured to execute the instructions to:
divide an uplink channel into at least two uplink sub-channels at the node when the channel is the uplink channel; and
receive uplink data packets that are sent by the at least one server using the uplink sub-channels.

10. The apparatus according to claim 9, wherein the computer processor is further configured to execute the instructions to:
make arbitration on the at least one server to obtain an arbitration result when the at least one server sends the uplink data packets using the uplink sub-channels and a conflict exists; and
receive, according to the arbitration result, an uplink data packet that is sent by a selected server using an uplink sub-channel connected to the selected server.

11. The apparatus according to claim 10, wherein the computer processor is further configured to execute the instructions to make the arbitration on the at least one server according to at least one of the following: a priority of the at least one server; or a priority of a data packet sent by the at least one server.

12. The apparatus according to claim 7, wherein the computer processor is further configured to execute the instructions to allocate bandwidth to the at least one server according to a bandwidth requirement of the at least one server connected to the sub-channels after the channel is divided into the at least two sub-channels at the node.

13. A switch, comprising:
a processor; and
a memory coupled to the processor,
wherein the memory stores an execution instruction,
wherein the processor communicates with the memory when the switch operates, and
wherein the processor executes the execution instruction to cause the switch to execute a method comprising:
dividing a channel into at least two sub-channels at a node, wherein the node is a point at which the channel and a backplane intersect; and
performing data transmission with at least one server using the sub-channels.

14. The method according to claim 2, wherein after dividing the channel into the at least two sub-channels at the node, the method further comprises allocating bandwidth to the at least one server according to a bandwidth requirement of the at least one server connected to the sub-channels.

15. The method according to claim 3, wherein after dividing the channel into the at least two sub-channels at the node, the method further comprises allocating bandwidth to the at least one server according to a bandwidth requirement of the at least one server connected to the sub-channels.

16. The method according to claim 4, wherein after dividing the channel into the at least two sub-channels at the node, the method further comprises allocating bandwidth to the at least one server according to a bandwidth requirement of the at least one server connected to the sub-channels.

17. The method according to claim 5, wherein after dividing the channel into the at least two sub-channels at the node, the method further comprises allocating bandwidth to the at least one server according to a bandwidth requirement of the at least one server connected to the sub-channels.

18. The apparatus according to claim 7, wherein the computer processor is further configured to execute the instructions to allocate bandwidth to the at least one server according to a bandwidth requirement of the at least one server connected to the sub-channels after the channel is divided into the at least two sub-channels at the node.

19. The apparatus according to claim 8, wherein the computer processor is further configured to execute the instructions to allocate bandwidth to the at least one server according to a bandwidth requirement of the at least one server connected to the sub-channels after the channel is divided into the at least two sub-channels at the node.

20. The apparatus according to claim 9, wherein the computer processor is further configured to execute the instructions to allocate bandwidth to the at least one server according to a bandwidth requirement of the at least one server connected to the sub-channels after the channel is divided into the at least two sub-channels at the node.
